(19) United States
(12) Patent Application Publication
(10) Pub. No.: US 2020/0094578 A1
(43) Pub. Date: Mar. 26, 2020

(54) PRINT DATA GENERATION DEVICE, PRINT DATA GENERATION METHOD OF PRINT DATA GENERATION DEVICE, PROGRAM, TAPE PRINTING DEVICE, AND TAPE PRINTING SYSTEM

(71) Applicant: SEIKO EPSON CORPORATION, Tokyo (JP)

(72) Inventors: Naofumi HIRABAYASHI, Suwa-shi (JP); Masahiro OIDA, Shiojiri-shi (JP); Hideki OIKAWA, Shiojiri-shi (JP); Makoto TAKADA, Woodbury, MN (US)

(73) Assignee: SEIKO EPSON CORPORATION, Tokyo (JP)

(21) Appl. No.: 16/566,169

(22) Filed: Sep. 10, 2019

(30) Foreign Application Priority Data
Sep. 21, 2018 (JP) 2018-176948

(51) Int. Cl. B41J 3/407; B41J 3/36; B41J 3/46

(52) U.S. Cl. CPC B41J 3/4075; B41J 3/46; B41J 3/36

(57) ABSTRACT

The print data generation device includes a controller that generates print data so that when the arrangement order change option that instructs a change in the arrangement order of a plurality of character strings to be printed side by side on a tape in the first direction of the tape is operated, the plurality of character strings is printed side by side in the first direction in the arrangement order different from that before the arrangement order change option is operated.

The present application is based on, and claims priority from JP Application Serial Number 2018-176948 filed on Sep. 21, 2018, the disclosure of which is hereby incorporated by reference herein in its entirety.

### BACKGROUND

### 1. Technical Field

The present disclosure relates to a print data generation device that generates print data for tape printing, a print data generation method of the print data generation device, a program, a tape printing device, and a tape printing system.

### 2. Related Art

In the related art, as disclosed in JP-A-2014-229155, a known label printer is provided which is capable of changing the arrangement order of a plurality of print character strings by swapping the field name and the offset value that the user inputs in the database field column and the record offset column corresponding to the upper row of the print character string label, and the field name and the offset value that the user inputs in the database field column and the record offset column corresponding to the lower row of the print character string label.

As described above, in the label printer in the related art, it is necessary to input field names and offset values one by one for a plurality of database field columns and a plurality of record offset columns in order to change the arrangement order of a plurality of print character strings. For this reason, there is a problem that the user has to perform complicated operations.

### SUMMARY

A print data generation device according to an aspect of the present disclosure includes a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

A print data generation method of a print data generation device according to an aspect of the present disclosure includes generating print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

In a non-transitory computer-readable storage medium storing a program according to an aspect of the present disclosure, the program causes a computer included in the print data generation device to function as a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

A tape printing device according to an aspect of the present disclosure includes a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated, and a printing unit that performs printing on the tape based on the print data.

A tape printing system according to an aspect of the present disclosure includes a print data generation device including a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated, and a tape printing device including a printing unit that performs printing on the tape based on the print data.

### BRIEF DESCRIPTION OF THE DRAWINGS

FIG. 1 is an external view of a handy printer.

FIG. 2 is a block diagram showing a control system of the handy printer.

FIG. 3 shows a first electric signal installation.

FIG. 4 shows a first label and a second label used in the first electric signal installation.

FIG. 5 is a flowchart showing a first embodiment of an operation procedure for producing the first label and the second label using the handy printer.

FIG. 6 shows an input editing screen.

FIG. 7 shows an editing menu screen.

FIG. 8 shows an input editing screen after selection of an arrangement order change option.

FIG. 9A is a flowchart showing a second embodiment of an operation procedure for producing the first label and the second label using the handy printer.

FIG. 9B shows the first label and the second label produced by the operation procedure of the second embodiment.

FIG. 10 shows a character size specification screen.

FIG. 11A is a flowchart showing a third embodiment of an operation procedure for producing the first label and the second label using the handy printer.

FIG. 11B shows a first label and a second label produced by the operation procedure of the third embodiment.

FIG. 12A is a flowchart showing a fourth embodiment of an operation procedure for producing the first label and the second label using the handy printer.

FIG. 12B shows a first label and a second label produced by the operation procedure of the fourth embodiment.

FIG. 13 shows a modification of the first label and the second label produced by the operation procedure of the fourth embodiment.

FIG. 14 is an external view of a smart device and a tape printer that constitute a tape printing system.

FIG. 15 is a block diagram showing a control system of the smart device and the tape printer.

FIG. 16 shows a second electric signal installation.

FIG. 17 shows a first label and a second label used in a second electric signal installation.

FIG. 18 is a flowchart showing an operation procedure of producing a first label and a second label using the tape printing system.

FIG. 19 shows a terminal input screen.

FIG. 20 shows a terminal input screen after an operation of an arrangement order change button.

### DESCRIPTION OF EXEMPLARY EMBODIMENTS

### Print Data Generation Device and Tape Printing Device

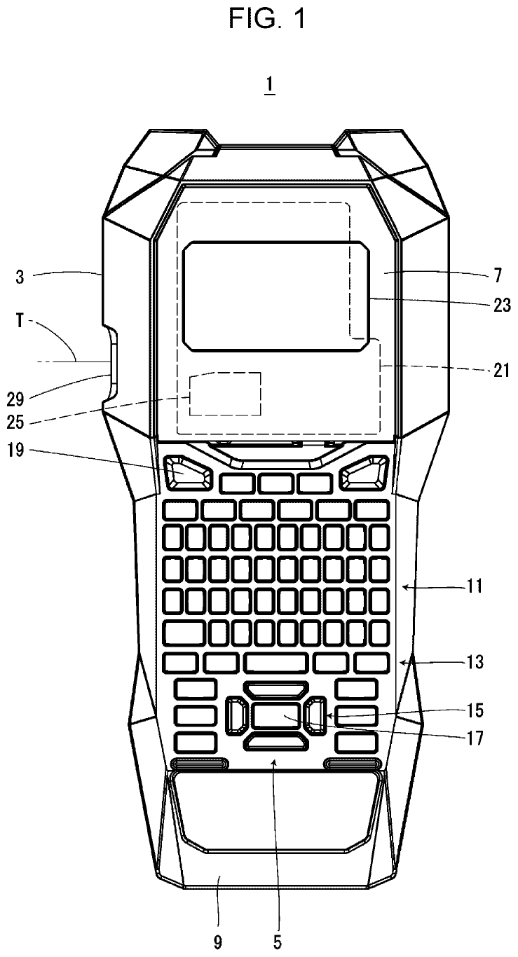

Hereinafter, a handy printer 1, which is an embodiment of a print data generation device and a tape printing device, will be described with reference to the attached drawings. As shown in FIG. 1, the handy printer 1 includes a device case 3, a plurality of operation keys 5, and a cartridge cover 7.

The device case 3 has a vertically long shape in which a substantially middle portion in the longitudinal direction is constricted so as to be easily held by the user. That is, the handy printer 1 is a so-called hand-held device that can be used while being held by one hand. A holding portion 9 is provided at one end of the device case 3 in the longitudinal direction. The holding portion 9 is a portion to be held when the handy printer 1 is carried.

The plurality of operation keys 5 includes a character key 11, an edit key 13, a cursor key 15, an enter key 17, a print key 19, and the like. The character key 11 is for inputting a character to be printed. The characters are concepts including hiragana, katakana, kanji, roman letters, numbers, symbols, pictograms and the like. The edit key 13 is for performing various editing such as changing the character size on the character input by the character key 11. The cursor key 15 is for moving the cursor and selecting various options. The enter key 17 is for deciding an option. The print key 19 is for instructing the print execution.

The cartridge cover 7 opens and closes a cartridge mounting portion 21 provided in the device case 3. A display 23 is provided on the outer face of the cartridge cover 7. The display 23 displays input information input by the operation key 5, various messages, and the like. The display 23 is an example of a display unit.

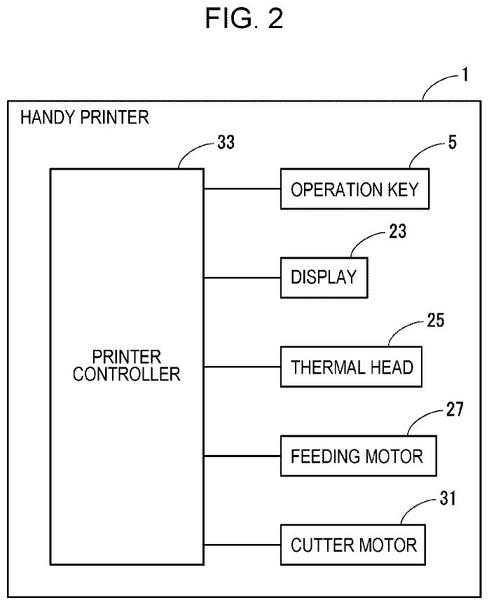

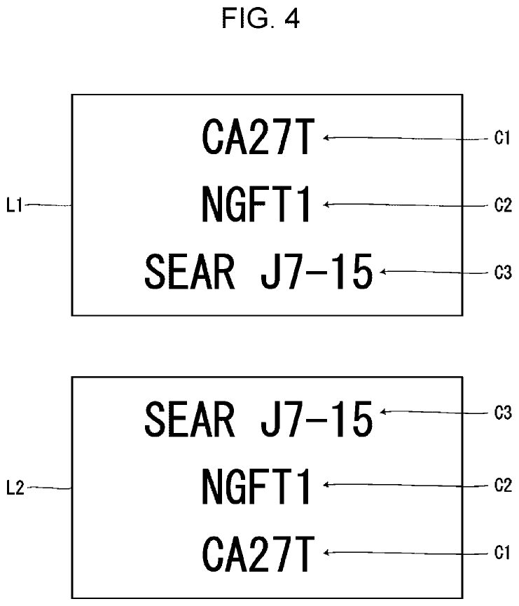

A tape cartridge (not shown) is detachably mounted to the cartridge mounting portion 21. In addition, the cartridge mounting portion 21 is provided with a thermal head 25. The handy printer 1 generates print data based on an input/edit operation to the operation key 5 and drives a feeding motor 27 (see FIG. 2) and the thermal head 25 based on the generated print data. As a result, a tape T is fed from the tape cartridge, and a character string C (see FIG. 4) based on the input information is printed on a tape T.

The tape T on which printing has been performed is discharged from a tape discharge port 29 provided on one side of the device case 3. A cutter (not shown) is provided between the cartridge mounting portion 21 and the tape discharge port 29. The cutter cuts the tape T in the width direction of the tape T using a cutter motor 31 (see FIG. 2) as a drive source. As a result, the printed portion of the tape T is separated and represents a label L (see FIG. 4).

As shown in FIG. 2, the handy printer 1 includes a printer controller 33. The printer controller 33 centrally controls the entire handy printer 1. Although not illustrated, the printer controller 33 includes a central processing unit (CPU), a random access memory (RAM), a read only memory (ROM), and a character generator ROM (CGROM). The CPU executes various programs stored in the ROM using the RAM. The CGROM stores dot pattern data of the character to be printed on the tape T. The printer controller 33 is an example of a computer that functions as a controller.

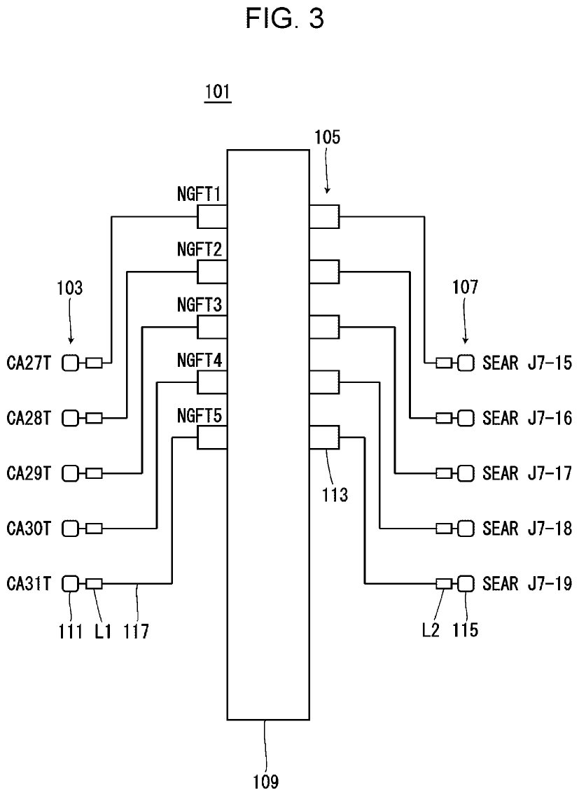

A first electric signal installation 101, which is an example of a railway electric signal installation using the label L produced by the handy printer 1, will be described based on FIG. 3.

The first electric signal installation 101 includes a starting end connection portion 103, a relay connection portion 105, and an ending end connection portion 107. The starting end connection portion 103 and the ending end connection portion 107 are separated by a wall 109, and the relay connection portion 105 is provided to the wall 109 so as to penetrate the wall 109.

The starting end connection portion 103 is provided with a plurality of starting end terminals 111, and different terminal numbers among the plurality of starting end terminals 111 are assigned to the respective starting end terminals 111. Similarly, the relay connection portion 105 is provided with a plurality of relay terminals 113, and different terminal numbers among the plurality of relay terminals 113 are assigned to the respective relay terminals 113. The ending end connection portion 107 is provided with a plurality of ending end terminals 115, and different terminal numbers among the plurality of ending end terminals 115 are assigned to the ending end terminals 115.

The starting end terminals 111 are coupled to the corresponding relay terminals 113 by a cable 117 which is an example of wiring. Further, the relay terminals 113 are coupled to the corresponding ending end terminals 115 by the cable 117. For example, the starting end terminal 111 whose terminal number is “CA27T” is coupled by the cable 117 to the relay terminal 113 whose terminal number is “NGFT1”. Further, the relay terminal 113 whose terminal number is “NGFT1” is coupled by the cable 117 to the ending end terminals 115 whose terminal number is “SEAR J7-15”.

A first label L1 is provided at the end of the cable 117 on the starting end terminal 111 side, and a second label L2 is provided at the end of the cable 117 on the ending end terminal 115 side. In addition, a method of providing the first label L1 on the cable 117 may include, for example, inserting the cable 117 through the first label L1 formed of the tube-like tape T, or winding the first label L1 formed of the strip-like tape T around the cable 117. The same applies to the method of providing the second label L2 on the cable 117.

As shown in FIG. 4, a starting end character string C1, a relay character string C2, and an ending end character string C3 are printed on the first label L1 and the second label L2 side by side in the width direction of the tape T. The width direction is an example of the first direction. The starting end character string C1, the relay character string C2, and the ending end character string C3 represent the terminal numbers of the starting end terminal 111, the relay terminal 113, and the ending end terminal 115, respectively, which are coupled to each other.

Not only the starting end character string C1 representing the terminal number of the starting end terminal 111 to which the cable 117 provided with the first label L1 is coupled, but also the relay character string C2 and the ending end character string C3 are printed on the first label L1 for the following reason, for example. That is, in the connection test between the starting end terminal 111 and the ending end terminal 115, an operator A who is located at the starting end connection portion 103 side reads out the starting end character string C1 printed on the first label L1, and when an operator B who is located at the ending end connection portion 107 side hears it, the operator B looks at the second label L2, so that it is possible to recognize the terminal numbers of the relay terminal 113 and the ending end terminal 115 corresponding to the terminal number represented by the read-out starting end character string C1. The same applies to the reason why the relay character string C2 and the starting end character string C1 in addition to the ending end character string C3 are printed on the second label L2.

Here, on the first label L1, the starting end character string C1 is printed in line 1, the relay character string C2 is printed in line 2, and the ending end character string C3 is printed in line 3. On the other hand, on the second label L2, the ending end character string C3 is printed in line 1, the relay character string C2 is printed in line 2, and the starting end character string C1 is printed in line 3. That is, the arrangement order of the starting end character string C1, the relay character string C2 and the ending end character string C3 is reversed in the width direction of the tape T for the first label L1 and the second label L2. On the first label L1, the starting end character string C1 is printed in line 1. This is because, for the first label L1, the starting end character string C1 is more important information than the ending end character string C3 since the first label L1 is provided at the end of the cable 117 on the starting end terminal 111 side. Similarly, on the second label L2, the ending end character string C3 is printed in line 1. This is because, for the second label L2, the ending end character string C3 is more important information than the starting end character string C1 since the second label L2 is provided at the end of the cable 117 on the ending end terminal 115 side.

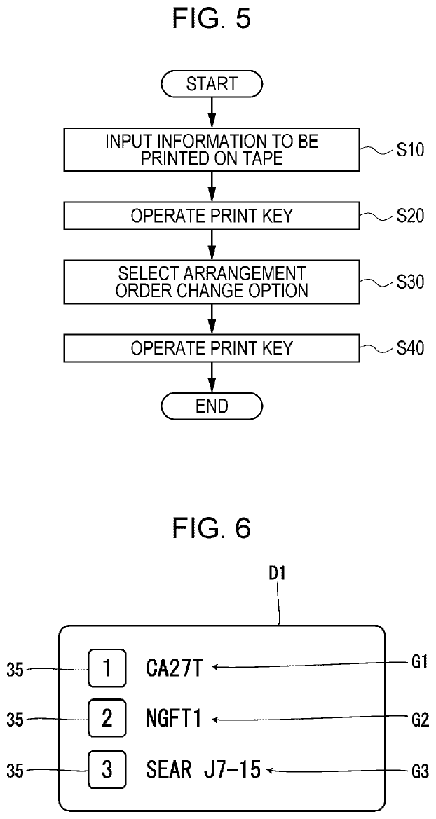

A first embodiment of an operation procedure for the user to produce the first label L1 and the second label L2 using the handy printer 1 will be described based on FIG. 5 with reference to FIGS. 6 to 8.

The user inputs information to be printed on the tape T in step S10. That is, as shown in FIG. 6, the user operates the character key 11 and the like to input desired information while an input editing screen D1 is displayed on the display 23. A line head mark 35 is displayed on the input editing screen D1. The line head mark 35 indicates on which line of the tape T the input information input following the line head mark 35 is to be printed. The user inputs the terminal number of the starting end terminal 111 following the line head mark 35 in line 1, inputs the terminal number of the relay terminal 113 following the line head mark 35 in line 2, and inputs the terminal number of the ending end terminal 115 following the line head mark 35 in line 3. As a result, on the input editing screen D1, starting end display information G1 representing the terminal number of the starting end terminal 111 is displayed in line 1, relay display information G2 representing the terminal number of the relay terminal 113 is displayed in line 2, and ending end display information G3 representing the terminal number of the ending end terminal 115 is displayed in line 3.

In step S20, the user operates the print key 19 to instruct the print execution. The printer controller 33 generates print data so that three character strings C corresponding to the input information input in the input editing screen D1, that is, the starting end character string C1, the relay character string C2, and the ending end character string C3, are printed side by side in the width direction of the tape T. That is, the printer controller 33 generates print data so that the starting end character string C1 is printed in line 1, the relay character string C2 is printed in line 2, and the ending end character string C3 is printed in line 3. The printer controller 33 also generates print data so that each character string C is printed with a character size according to the number of lines. As a result, the first label L1 shown in FIG. 4 is produced.

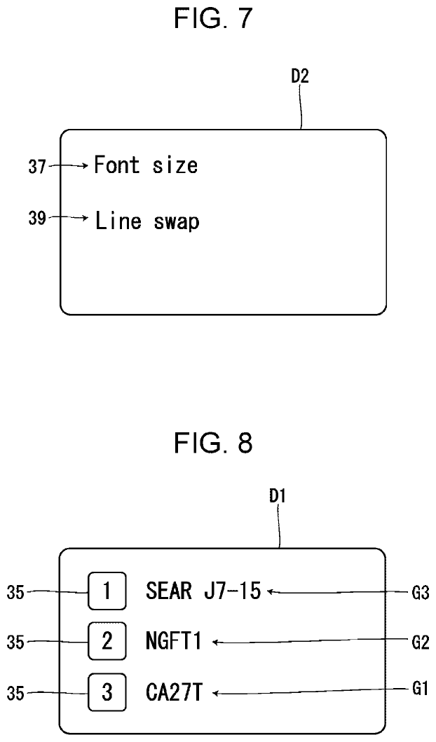

In step S30, the user operates the edit key 13 to display an editing menu screen D2 on the display 23 as shown in FIG. 7. Thereafter, the user operates the cursor key 15 and the enter key 17 to select an arrangement order change option 39 from among a plurality of options displayed on the editing menu screen D2. The arrangement order change option 39 is for swapping the plurality of character strings C so that the arrangement order of the plurality of character strings C in the width direction of the tape T is reversed. That is, the arrangement order change option 39 is an example of an arrangement order change instruction button. As described above, the user selects the arrangement order change option 39 from among the plurality of options displayed on the editing menu screen D2. In other words, the arrangement order change instruction is one of the print data editing functions.

When the arrangement order change option 39 is selected, the input editing screen D1 is displayed on the display 23 again as shown in FIG. 8, and a plurality of pieces of display information G is displayed on the input editing screen D1 with a arrangement order different from that before selection of the arrangement order change option 39. That is, on the input editing screen D1, the ending end display information G3 is displayed in line 1, the relay display information G2 is displayed in line 2, and the starting end display information G1 is displayed in line 3.

In step S40, the user operates the print key 19 to instruct the print execution. The printer controller 33 generates print data so that the three character strings C, that is, the starting end character string C1, the relay character string C2, and the ending end character string C3, are printed side by side in the width direction of the tape T in the arrangement order different from that before selection of the arrangement order change option 39. That is, the printer controller 33 generates print data so that the ending end character string C3 is printed in line 1, the relay character string C2 is printed in line 2, and the starting end character string C1 is printed in line 3. The printer controller 33 also generates print data so that each character string C is printed with a character size according to the number of lines. As a result, the second label L2 shown in FIG. 4 is produced. In addition, although the operation procedure is set so as to operate the print key 19 separately when producing the first label L1 and the second label L2, the present disclosure is not limited to this. The operation procedure may be set such that step S20 in FIG. 5 is omitted and the arrangement order change option 39 in step S30 is selected, and then the print key 19 is operated once in step S40 to continuously produce the first label L1 and the second label L2.

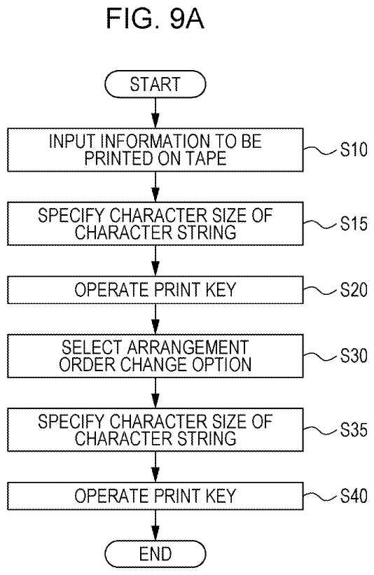

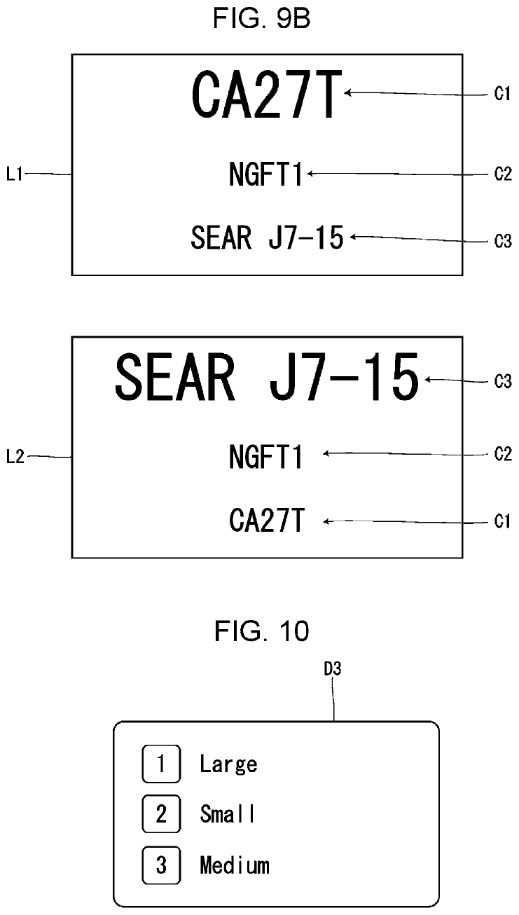

A second embodiment of the operation procedure for producing the first label L1 and the second label L2 will be described based on FIG. 9A. FIG. 9B shows an example of the first label L1 and the second label L2 produced by the operation procedure of the second embodiment.

In the operation procedure of the second embodiment differs from the operation procedure of the first embodiment in that after step S10, the user specifies, in step S15, the character size of the character string C before step S20, and after step S30, the user specifies, in step S35, the character size of the character string C before step S40.

In step S15, the user operates the edit key 13 to display the editing menu screen D2 on the display 23 as shown in FIG. 7. Thereafter, the user operates the cursor key 15 and the enter key 17 to select a character size option 37 from among a plurality of options displayed on the editing menu screen D2. When the character size option 37 is selected, a character size specification screen D3 is displayed on the display 23 as shown in FIG. 10. In the character size specification screen D3, the user may operate the cursor key 15 and the enter key 17 to specify the character size of the character string C at, for example, five levels of “very small”, “small”, “medium”, “large” and “very large” for each line. The user also specifies the character size of the character string C in the same manner in step S35.

For example, in step S15, it is assumed that the character size of the starting end character string C1 in line 1 is specified as “large”, the character size of the relay character string C2 in line 2 is specified as “small”, and the character size of the ending end character string C3 in line 3 is specified as “small”. In step S35, it is assumed that the character size of the ending end character string C3 in line 1 is specified as “large”, the character size of the relay character string C2 in line 2 is specified as “small”, and the character size of the starting end character string C1 in line 3 is specified as “small”.

In this case, when the print execution instruction in step S20 is performed, the printer controller 33 generates print data so that the starting end character string C1 in line 1 is printed with the character size of “large”, the relay character string C2 in line 2 is printed with the character size of “small”, and the ending end character string C3 in line 3 is printed with the character size of “small”. As a result, the first label L1 shown in FIG. 9B is produced. In addition, when the print execution instruction in step S40 is performed, the printer controller 33 generates print data so that the ending end character string C3 in line 1 is printed with the character size of “large”, the relay character string C2 in line 2 is printed with the character size of “small”, and the starting end character string C1 in line 3 is printed with the character size of “small”. As a result, the second label L2 shown in FIG. 9B is produced. Here, as described above, the arrangement order change instruction is one of the print data editing functions. That is, the arrangement order change instruction can be used in combination with other print data editing functions including character size specification. In addition, the character size of the character string C is one of the “attribute of character string C” to be described later.

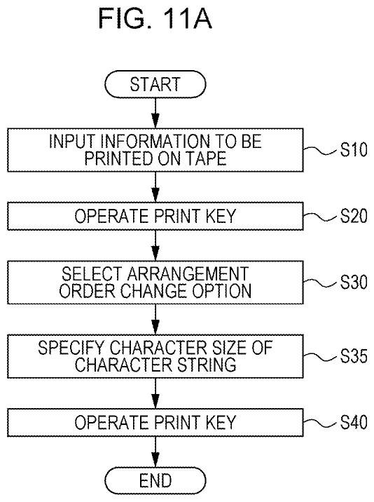

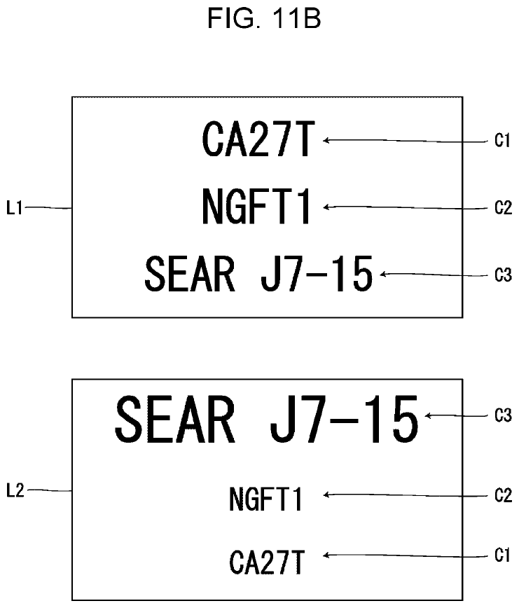

A third embodiment of the operation procedure for producing the first label L1 and the second label L2 will be described based on FIG. 11A. FIG. 11B shows an example of the first label L1 and the second label L2 produced by the operation procedure of the third embodiment.

The operation procedure of the third embodiment differs from the operation procedure of the first embodiment in that after step S30, the user specifies, in step S35, the character size of the character string C before step S40. After step S10, the user does not specify the character size of the character string C and before step S20. In step S35, as in the second embodiment, it is assumed that the character size of the ending end character string C3 in line 1 is specified as “large”, the character size of the relay character string C2 in line 2 is specified as “small”, and the character size of the starting end character string C1 in line 3 is specified as “small”.

In this case, when the print execution instruction in step S20 is performed, the printer controller 33 generates print data so that each character string C is printed with a character size corresponding to the number of lines. As a result, the first label L1 shown in FIG. 11B is produced. In addition, when the print execution instruction in step S40 is performed, the printer controller 33 generates print data so that the ending end character string C3 in line 1 is printed with the character size of “large”, the relay character string C2 in line 2 is printed with the character size of “small”, and the starting end character string C1 in line 3 is printed with the character size of “small”. As a result, the second label L2 shown in FIG. 11B is produced.

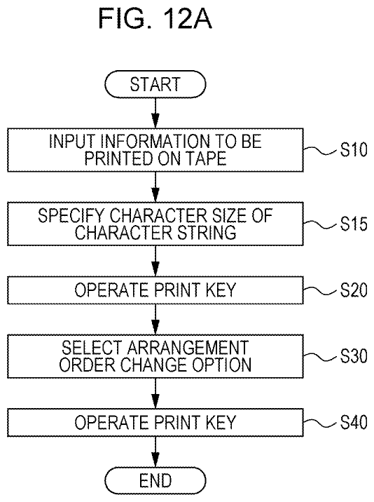

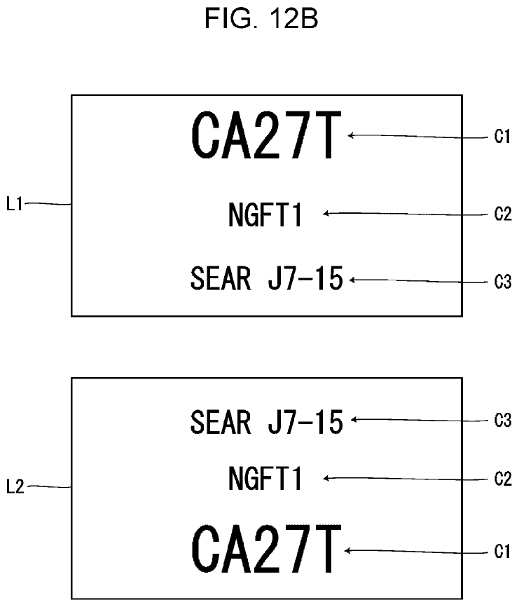

A fourth embodiment of the operation procedure for producing the first label L1 and the second label L2 will be described based on FIG. 12A. FIG. 12B shows an example of the first label L1 and the second label L2 produced by the operation procedure of the fourth embodiment.

The operation procedure of the fourth embodiment differs from the operation procedure of the first embodiment in that after step S10, the user specifies, in step S15, the character size of the character string C before step S20. After step S30, the user does not specify the character size of the character string C and before step S40. In step S15, as in the second embodiment, it is assumed that the character size of the starting end character string C1 in line 1 is specified as “large”, the character size of the relay character string C2 in line 2 is specified as “small”, and the character size of the ending end character string C3 in line 3 is specified as “small”.

In this case, when the print execution instruction in step S20 is performed, the printer controller 33 generates print data so that the starting end character string C1 in line 1 is printed with the character size of “large”, the relay character string C2 in line 2 is printed with the character size of “small”, and the ending end character string C3 in line 3 is printed with the character size of “small”. As a result, the first label L1 shown in FIG. 12B is produced. In addition, when the print execution instruction in step S40 is performed, the printer controller 33 generates print data so that each character string C is printed with the character size specified with respect to the same character string C before a change in the arrangement order. That is, the printer controller 33 generates print data so that the ending end character string C3 in line 1 is printed with the character size of “small” specified with respect to the same ending end character string C3 before a change in the arrangement order, the relay character string C2 in line 2 is printed with the character size of “small” specified with respect to the same relay character string C2 before a change in the arrangement order, and the starting end character string C1 in line 3 is printed with the character size of “large” specified with respect to the same starting end character string C1 before a change in the arrangement order. As a result, the second label L2 shown in FIG. 12B is produced.

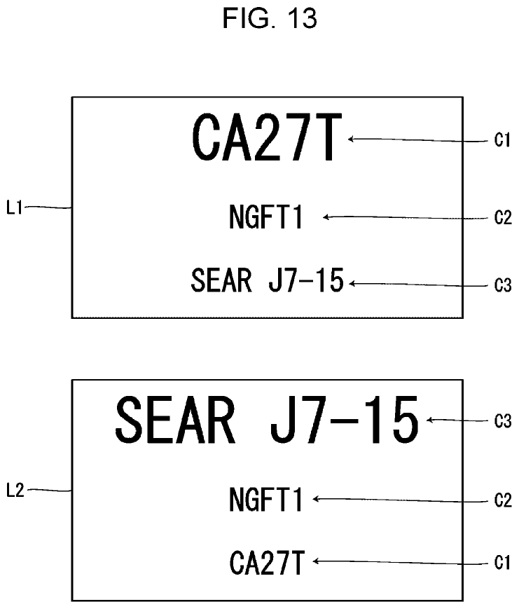

When the print execution instruction in step S40 is performed, the printer controller 33 may generate print data so that the character string C in line n, where n is an integer greater than or equal to one, after a change in the arrangement order is printed with the character size specified with respect to the character string C in line n before a change in the arrangement order. That is, when the print execution instruction in step S40 is performed, the printer controller 33 generates print data so that the ending end character string C3 in line 1 after a change in the arrangement order has the character size of “large” specified with respect to the starting end character string C1 in line 1 before a change in the arrangement order. In addition, the printer controller 33 generates print data so that the relay character string C2 in line 2 after a change in the arrangement order has the character size of “small” specified with respect to the relay character string C2 in line 2 before a change in the arrangement order. In addition, the printer controller 33 generates print data so that the starting end character string C1 in line 3 after a change in the arrangement order has the character size of “small” specified with respect to the ending end character string C3 in line 3 before a change in the arrangement order. In this case, the first label L1 and the second label L2 shown in FIG. 13 are produced.

While the handy printer 1 has been described as an embodiment of the print data generation device and the tape printing device previously, the print data generation device and the tape printing device may not be a hand-held device such as the handy printer 1, but may be, for example, a desktop machine.

### Tape Printing System

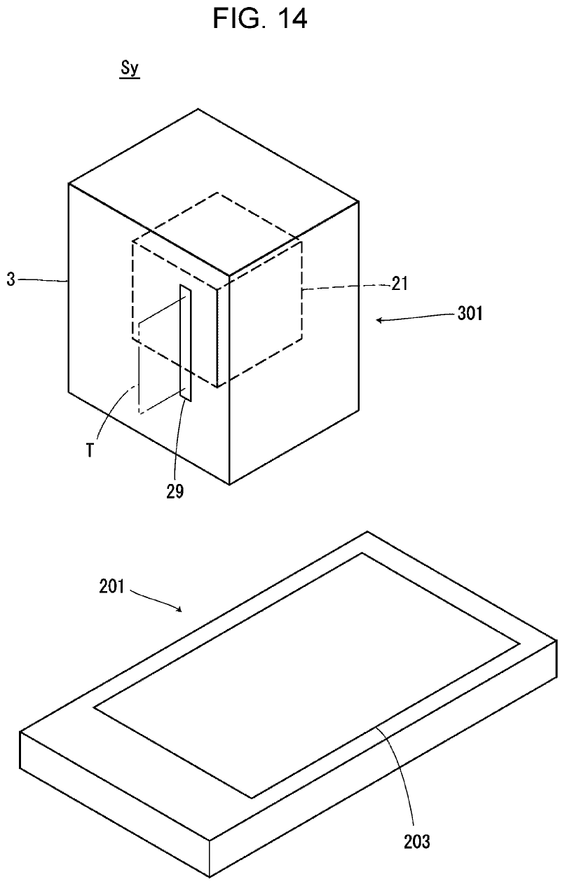

Subsequently, a tape printing system Sy, which is an embodiment of the tape printing system, will be described. As shown in FIG. 14, the tape printing system Sy includes a smart device 201, which is an example of a data generation device, and a tape printer 301, which is an example of a tape printing device. The smart device 201 generates print data and transmits the generated print data to the tape printer 301. The tape printer 301 receives the print data transmitted from the smart device 201, and performs printing on the tape T based on the received print data.

An application program corresponding to the tape printer 301 is installed in the smart device 201. The smart device 201 includes a touch panel 203. The touch panel 203 displays various screens and receives various operations from the user. The touch panel 203 is an example of a display unit. Examples of the smart device 201 may include a smartphone, a tablet terminal, and the like.

Unlike the handy printer 1, the tape printer 301 is a desktop machine, and is configured similar to the handy printer 1 except that the display 23 and the operation key 5 are not provided. Among the components of the tape printer 301, components corresponding to the components of the handy printer 1 are given the same names and reference numerals, and the detailed description is omitted. The tape printer 301 may be a hand-held device, as with the handy printer 1. As in the handy printer 1, the tape printer 301 may include the display 23 and the operation key 5.

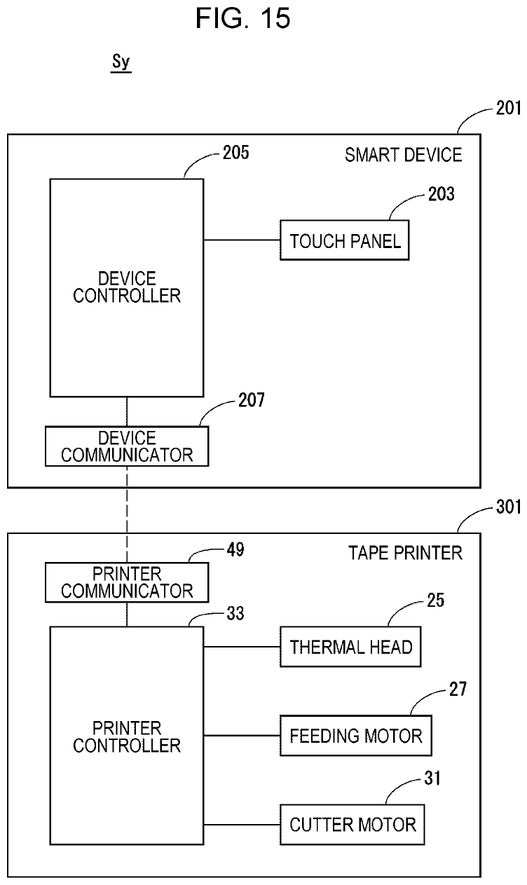

The control system of the smart device 201 and the tape printer 301 will be described based on FIG. 15. The smart device 201 includes a device controller 205 and a device communicator 207. The device controller 205 centrally controls the entire smart device 201. Although not shown, the device controller 205 includes a CPU, a RAM, and a flash memory. The CPU uses the RAM to execute various programs such as the above application program stored in the flash memory. The device controller 205 is an example of a computer that functions as a controller. The device communicator 207 exchanges various commands and various data with a printer communicator 49.

The tape printer 301 includes a printer controller 33 and a printer communicator 49. The printer controller 33 centrally controls the entire tape printer 301. The printer communicator 49 exchanges various commands and various data with the device communicator 207.

A second electric signal installation 401, which is an example of a railway electric signal installation using the label L produced by the tape printing system Sy, will be described based on FIG. 16. The second electric signal installation 401 is configured similar to the first electric signal installation 101 described above except that the relay connection portion 105 is not provided. Among the components of the second electric signal installation 401, components corresponding to the components of the first electric signal installation 101 are given the same names and reference numerals, and detailed description thereof is omitted.

The starting end terminal 111 and the ending end terminal 115 are directly coupled by the cable 117 without through the relay terminal 113. In addition, the rack number and the rack location number with “1-1” are assigned to the starting end connection portion 103, and the rack number and the rack location number with “2-3” are assigned to the ending end connection portion 107.

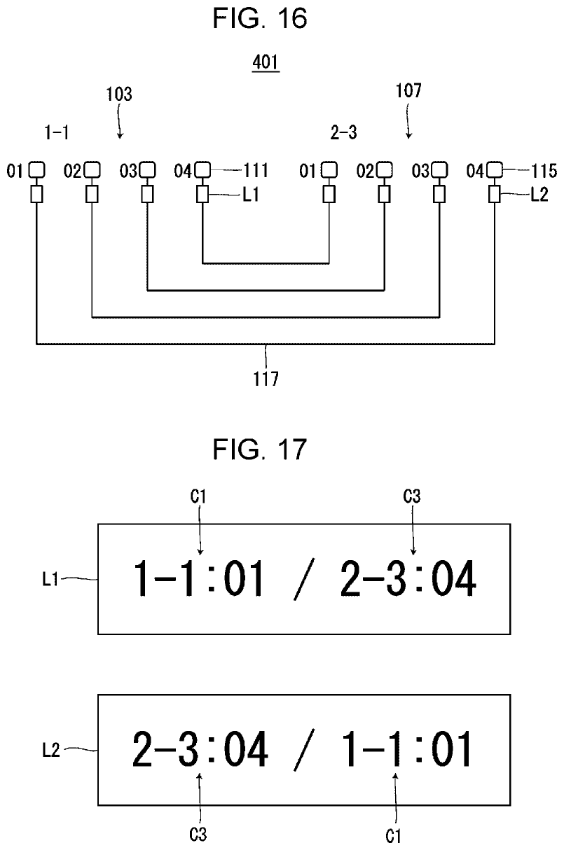

As shown in FIG. 17, the starting end character string C1 and the ending end character string C3 used for the second electric signal installation 401 are printed on the first label L1 and the second label L2 side by side in the lengthwise direction of the tape T. The starting end character string C1 represents the rack number and rack location number of the starting end connection portion 103, and the terminal number of the starting end terminal 111. Similarly, the ending end character string C3 represents the rack number and rack location number of the ending end connection portion 107, and the terminal number of the ending end terminal 115.

Here, on the first label L1, the starting end character string C1 is printed in the first paragraph, and the ending end character string C3 is printed in the second paragraph. On the other hand, on the second label L2, the ending end character string C3 is printed in the first paragraph, and the starting end character string C1 is printed in the second paragraph. That is, for the first label L1 and the second label L2, the arrangement order of the starting end character string C1 and the ending end character string C3 is reversed.

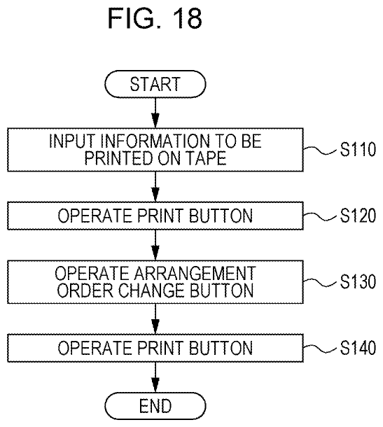

The operation procedure for the user to produce the first label L1 and the second label L2 using the tape printing system Sy will be described based on FIG. 18.

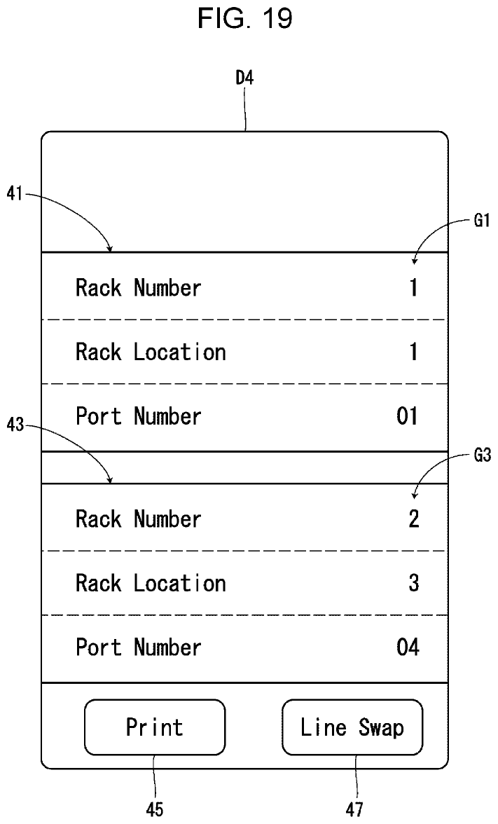

The user inputs information to be printed on the tape T in step 5110. That is, as shown in FIG. 19, the user operates, for example, the software keyboard displayed on the touch panel 203 in a state where a terminal input screen D4 is displayed on the touch panel 203, and inputs desired information. A first input field 41 and a second input field 43 are displayed in the terminal input screen D4. The input information input to the first input field 41 is printed in the first paragraph, and the input information input to the second input field 43 is printed in the second paragraph. The user inputs the rack number and rack location number of the starting end connection portion 103 and the terminal number of the starting end terminal 111 in the first input field 41, and the rack number and rack location number of the ending end connection portion 107 and the terminal number of the ending end terminal 115 in the second input field 43. As a result, the starting end display information G1 representing the rack number and rack location number of the starting end connection portion 103 and the terminal number of the starting end terminals 111 is displayed in the first input field 41 of the terminal input screen D4. Similarly, the ending end display information G3 representing the rack number and rack location number of the ending end connection portion 107 and the terminal number of the ending end terminal 115 is displayed in the second input field 43 of the terminal input screen D4.

In step S120, the user operates a print button 45 displayed on the touch panel 203 to instruct print execution. The device controller 205 generates print data so that two character strings C corresponding to the input information input in terminal input screen D4, that is, the starting end character string C1 and the ending end character string C3, are printed side by side in the lengthwise direction of the tape T. That is, the device controller 205 generates print data so that the starting end character string C1 is printed in the first paragraph and the ending end character string C3 is printed in the second paragraph, and transmits the generated print data to the smart device 201. The tape printer 301 produces the first label L1 based on the print data received from the smart device 201.

In step S130, the user operates an arrangement order change button 47 displayed on the terminal input screen D4 in a state where the terminal input screen D4 is displayed on the display 23 again. The arrangement order change button 47 is for swapping paragraphs of a plurality of character strings C so that the arrangement order of the plurality of character strings C in the lengthwise direction of the tape T is reversed. That is, the arrangement order change button 47 is an example of the arrangement order change instruction button.

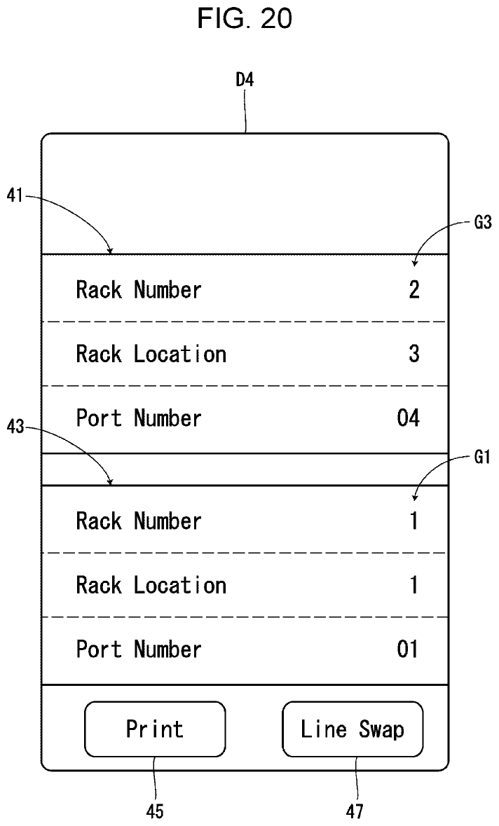

When the arrangement order change button 47 is operated, as shown in FIG. 20, a plurality of pieces of display information G is displayed on the terminal input screen D4 in an arrangement order different from that before the arrangement order change button 47 is operated. That is, the ending end display information G3 is displayed in the first input field 41, and the starting end display information G1 is displayed in the second input field 43.

In step S140, the user operates the print button 45 to instruct print execution. The device controller 205 generates print data so that two character strings C, that is, the starting end character string C1 and the ending end character string C3, are printed side by side in the lengthwise direction of the tape T in the arrangement order different from that before operation of the arrangement order change button 47. That is, the device controller 205 generates print data so that the ending end character string C3 is printed in the first paragraph and the starting end character string C1 is printed in the second paragraph, and transmits the generated print data to the smart device 201. The tape printer 301 produces the second label L2 based on the print data received from the smart device 201. In the tape printing system, the first label L1 and the second label L2 may be sequentially printed by a single printing operation. In this case, in addition to the print button 45, the pair print button may be provided on the terminal input screen D4.

In addition, s in the handy printer 1, the smart device 201 may be configured such that the character size may be specified before and after the change in the arrangement order of the plurality of character strings C.

### Other Modifications

It is to be understood that the tape printer 301 and the tape printing system Sy are not limited to the above embodiments, and various configurations can be adopted without departing from the scope of the disclosure. For example, the above-described embodiments can be modified into the following modes in addition to the above embodiments.

The number of character strings C to be printed on the tape T may be plural. That is, the number of character strings C to be printed on the tape T is not limited to 2 or 3, and may be 4 or more.

The method of changing the arrangement order of the plurality of character strings C is not limited to the method of reversing the arrangement order, and the following method may be used. For example, the method of shifting the arrangement order of a plurality of character strings C by a desired number, for example, the method may be used in which the character string C in line 1 is shifted to line 2, the character string C in line 2 is shifted to line 3, and the character string C in the last line is shifted to line 1. Alternatively, the plurality of character strings C may be rearranged according to a desired rule, for example, in alphabetical order. Alternatively, the arrangement order of the plurality of character strings C may be changed randomly. Furthermore, the user may select one from among these methods.

The arrangement order change instruction button that instructs a change in the arrangement order of the plurality of character strings C is not limited to the one displayed on the display 23 or the touch panel 203, such as the arrangement order change option 39 or the arrangement order change button 47. For example, one of the operation keys 5 of the tape printer 301, or an operation button provided on the housing of the smart device 201 may be made to function as an arrangement order change instruction button.

The printer controller 33 generates print data so that each character string C is printed with the character size specified with respect to the same character string C before a change in the arrangement order in the third modification, and generates print data so that the character string C in line n after a change in the arrangement order is printed with the character size specified with respect to the character string C in line n before a change in the arrangement order in the fourth modification. The configuration may be selected from among these modifications by the user.

The handy printer 1 and the smart device 201 may be configured such that in addition to the character size, for example, the attribute such as (1) a font, (2) a decoration such as italics or bold, (3) an alignment such as front alignment, center alignment, rear alignment, and the like can be specified for each character string C based on the user's operation. That is, the attribute of the character string C is a concept including a character size, a font, a decoration, an assignment, and the like. The handy printer 1 and the smart device 201 have an editing function for editing the attribute of the character string C included in the print data.

The direction in which the plurality of character strings C are arranged is not limited to the width direction of the tape T or the lengthwise direction of the tape T. For example, the direction may obliquely intersect the width direction of the tape T. That is, the first direction of the tape T is a concept including the width direction of the tape T, the lengthwise direction of the tape T, and the direction obliquely intersecting the width direction of the tape T.

The tape printer 301 and the tape printing system Sy may use the function of changing the arrangement order of the plurality of character strings C together with the serial number printing function. For example, when “A1” is input as input information in line 1, and “B3” is input as input information in line 2 the tape printer 301 and the tape printing system Sy produces, with the serial number printing function, the label L on which the character string C with “A1” in line 1 and “B3” in line 2 is printed, the label L on which the character string C with “A2” in line 1 and “B2” in line 2 is printed, and the label L on which the character string C with “A3” in line 1 and “B1” in line 2 is printed. Subsequently, after changing the arrangement order of the plurality of character strings C with the arrangement order change function, the tape printer 301 and the tape printing system Sy produces, with the serial number printing function, the label L on which the character string C with “B3” in line 1 and “A1” in line 2 is printed, the label L on which the character string C with “B2” in line 1 and “A2” in line 2 is printed, and the label L on which the character string C with “B1” in line 1 and “A3” in line 2 is printed.

When the tape T has a plurality of paragraphs, and at least one paragraph includes a plurality of lines of character strings C, the configuration may be such that the user can select whether to change the arrangement order of the lines or to change the arrangement order of the paragraphs. Here, when changing the arrangement order of the lines, the configuration may be such that the user can select whether to change the arrangement order of the lines in all paragraphs or change the arrangement order of the lines only in the paragraph at the cursor position. Moreover, when changing the arrangement order of the paragraphs, it is preferable to change the arrangement order of the paragraphs while maintaining the arrangement order of the lines in each paragraph.

The handy printer 1 produces not only the first label L1 and the second label L2 used for the first electric signal installation 101, but also the first label L1 and the second label L2 used for the second electric signal installation 401. Similarly, the tape printing system Sy may produce not only the first label L1 and the second label L2 used for the second electric signal installation 401, but also the first label L1 and the second label L2 used for the first electric signal installation 101. Furthermore, the label L produced by the handy printer 1 and the tape printing system Sy is not limited to the one used for the electric signal installation such as the first electric signal installation 101 and the second electric signal installation 401, and may be the one used for an electric installation, such as a patch panel, other than the electric signal installation. Further, the description represented by the character string C is not particularly limited.

The printing unit is not limited to the thermal head 25 and may employ a printing method such as an ink jet method or an electrophotographic method.

The print data generation device constituting the tape printing system Sy is not limited to the smart device 201, and may be, for example, a personal computer.

The application program stored in a computer readable recording medium (a CD-ROM, a flash memory, and the like) may be provided.

The above-described embodiments and modifications may be combined with each other.

### APPENDIX

The print data generation device, the print data generation method of the print data generation device, the program, the tape printing device, and the tape printing system will be additionally described below.

The print data generation device includes a controller that generates print data so that when the arrangement order change instruction button that instructs a change in the arrangement order of a plurality of character strings to be printed side by side with respect to the tape in the first direction of the tape is operated, the plurality of character strings is printed side by side in the first direction in the arrangement order different from that before the arrangement order change instruction button is operated.

The print data generation method of a print data generation device includes generating print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

In a non-transitory computer-readable storage medium storing a program, the program causes a computer included in the print data generation device to function as a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

According to this configuration, it is possible to change the arrangement order of the plurality of character strings with a simple operation of operating the arrangement order change instruction button.

Preferably, the controller preferably generates print data in which when the arrangement order change instruction button is operated, an arrangement order of the plurality of character strings in the first direction is reversed from an arrangement order before the arrangement order change instruction button is operated.

According to this configuration, it is possible to reverse the arrangement order of the plurality of character strings with a simple operation of operating the arrangement order change instruction button.

Preferably, the controller generates print data so that after the operation of the arrangement order change instruction button, when an attribute of the character string is specified based on an operation of a user, the character string is printed with the attribute after specified.

According to this configuration, it is possible to specify the attribute of the character string after the operation of the arrangement order change instruction button.

Preferably, the controller generates print data so that after an attribute of the character string are specified based on an operation of a user, when the arrangement order change instruction button is operated, the character string is printed with the attribute specified before a change in an arrangement order with respect to the same character string.

According to this configuration, it is possible to generate the print data so that the character string is printed with the specified attribute with respect to the same character string before a change in the arrangement order even after a change in the arrangement order of the plurality of character strings.

Preferably, the controller generates print data so that after an attribute of the character string are specified based on an operation of a user, when the arrangement order change instruction button is operated, the n-th character string, where n is an integer greater than or equal to one, after a change in an arrangement order is printed with the attribute specified with respect to the character string in line n before a change in the arrangement order.

According to this configuration, it is possible to generate the print data so that the character string in line n is printed with the attribute specified with respect to the n-th character string before a change in the arrangement order even after a change in the arrangement order of the plurality of character strings.

Preferably, the controller displays the arrangement order change instruction button on a display unit based on an operation of a user.

According to this configuration, it is possible to simplify the device configuration without providing the arrangement order change instruction button separately from the display unit.

Preferably, the first direction is a width direction of the tape.

According to this configuration, it is possible to change the arrangement order of the plurality of character strings in the width direction of the tape.

Preferably, the first direction is a lengthwise direction of the tape.

According to this configuration, it is possible to change the arrangement order of the plurality of character strings in the lengthwise direction of the tape.

Preferably, the controller generates the print data for printing a first label provided at one end of wiring used for an electric installation before the arrangement order change instruction button is operated, and generates the print data for printing a second label provided at the other end of the wiring after the arrangement order change instruction button is operated.

According to this configuration, it is possible to produce the first label and the second label used for the electric installation with a simple operation.

Preferably, the electric installation is a railway electric signal installation.

According to this configuration, it is possible to produce the first label and the second label used for the railway electric signal installation with a simple operation.

A tape printing device includes a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated, and a printing unit that performs printing on the tape based on the print data.

A tape printing system includes a print data generation device including a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated, and a tape printing device including a printing unit that performs printing on the tape based on the print data.

According to this configuration, it is possible to produce a label in which the arrangement order of the plurality of character strings is changed with a simple operation of operating the arrangement order change instruction button.

What is claimed is:

1. A print data generation device comprising:
a display unit; and
a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

2. The print data generation device according to claim 1, wherein the controller generates print data in which when the arrangement order change instruction button is operated, an arrangement order of the plurality of character strings in the first direction is reversed from an arrangement order before the arrangement order change instruction button is operated.

3. The print data generation device according to claim 1, wherein the controller generates the print data so that after the operation of the arrangement order change instruction button, when an attribute of the character string is specified based on an operation of a user, the character string is printed with the attribute after specified.

4. The print data generation device according to claim 1, wherein the controller generates the print data so that after an attribute of the character string are specified based on an operation of a user, when the arrangement order change instruction button is operated, the character string is printed with the attribute specified before a change in an arrangement order with respect to the same character string.

5. The print data generation device according to claim 1, wherein the controller generates the print data so that after an attribute of the character string are specified based on an operation of a user, when the arrangement order change instruction button is operated, the character string in line n, where n is an integer greater than or equal to one, after a change in an arrangement order is printed with the attribute specified with respect to the character string in line n before the change in the arrangement order.

6. The print data generation device according to claim 1, wherein the controller displays the arrangement order change instruction button on the display unit based on an operation of a user.

7. The print data generation device according to claim 1, wherein the first direction is a width direction of the tape.

8. The print data generation device according to claim 1, wherein the first direction is a lengthwise direction of the tape.

9. The print data generation device according to claim 1, wherein the controller generates the print data for printing a first label provided at one end of wiring used for an electric installation before the arrangement order change instruction button is operated, and generates the print data for printing a second label provided at the other end of the wiring after the arrangement order change instruction button is operated.

10. The print data generation device according to claim 9, wherein the electric installation is a railway electric signal installation.

11. A print data generation method of a print data generation device, the method comprising generating print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

12. A non-transitory computer-readable storage medium storing a program, the program causing a computer included in the print data generation device to function as a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated.

13. A tape printing device comprising:
a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated; and
a printing unit that performs printing on the tape based on the print data.

14. A tape printing system comprising:
a print data generation device including a controller that generates print data so that when an arrangement order change instruction button that instructs a change in an arrangement order of a plurality of character strings to be printed side by side on a tape in a first direction of the tape is operated, the plurality of character strings is printed side by side in the first direction in an arrangement order different from an arrangement order before the arrangement order change instruction button is operated; and
a tape printing device including a printing unit that performs printing on the tape based on the print data.
